(19) United States
(12) Patent Application Publication
(10) Pub. No.: US 2013/0136383 A1
(43) Pub. Date: May 30, 2013

(54) LINEAR SLIDING BLOCK STRUCTURE

(71) Applicant: Kuo-Le Tsao, New Taipei City (TW)

(72) Inventor: Kuo-Le Tsao, New Taipei City (TW)

(21) Appl. No.: 13/436,865

(22) Filed: Mar. 31, 2012

(30) Foreign Application Priority Data
Nov. 25, 2011 (TW) 100222332

(51) Int. Cl. F16C 29/06

(52) U.S. Cl. 384/43

(57) ABSTRACT

A linear sliding block structure includes a base block, two circulation-guiding blocks coupled to two opposing ends of the base block and a plurality of rolling balls. The base block has a sliding groove, load-bearing tracks and non-load tracks. Each of the circulation-guiding blocks has a sliding passage and a circulation track to interconnect the load-bearing tracks and the non-load tracks. Each of the circulation-guiding blocks includes a first body and a second body. The first body includes a rigid component and a soft cover component. The soft cover component is formed with at least one stop portion disposed close to the first passage of the rigid component to be against the linear sliding rail.

### CROSS REFERENCE TO RELATED APPLICATIONS

This application is based upon and claims the benefit of priority from the prior Taiwan Patent Application No. 100222332, filed on Nov. 25, 2011, the entire contents of which are incorporated herein by reference.

### BACKGROUND OF THE INVENTION

(a) Field of the Invention

The present invention relates to a linear sliding block structure, and more particularly to a linear sliding block to carry an object for enabling the object to move along a linear sliding rail.

(b) Description of the Prior Art

A linear sliding rail and a linear sliding block are one of common rectilinear motion devices. A conventional linear sliding block comprises a base block, two circulation-guiding blocks, and a plurality of rolling balls. The bottom of the base block has a sliding groove to fit on the linear sliding rail and a pair of load-bearing tracks symmetrically disposed at two opposite lateral sides of the sliding groove. The base block has non-load tracks extending through opposing front and rear ends thereof. The circulation-guiding blocks are formed by plastic injection and respectively coupled to the opposing front and rear ends of the base block, such that the load-bearing tracks communicate with the non-load tracks through the circulation-guiding blocks. The rolling balls are received in the load-bearing tracks and the non-load tracks. The two outer ends of the linear sliding block are provided with a configuration, such as a scrape plate to expel iron filings, dust or foreign objects on the surface of the linear sliding rail. The scrape plate has a trough and a soft scrape piece attached to the trough. The soft scrape piece leans against the surface of the linear sliding rail to expel the iron filings, dust and foreign objects when the linear sliding block is moved.

The conventional circulation-guiding block is made by plastic injection which centers the stress to result in deformation. It is difficult to manufacture and assemble the circulation-guiding block. Besides, the conventional circulation-guiding block has a circulation track for the rolling balls to make a U-turn between the load-bearing tracks and the non-load tracks. The conventional circulation-guiding block also has an oil passage therein, so its configuration is complicated. The soft scrape piece cannot be secondarily injection-molded on the circulation-guiding block. It must be made and assembled separately. Thus, the manufacture procedures of the conventional circulation-guiding block and the soft scrape piece are complicated and the manufacture cost cannot be lowered. Accordingly, the inventor of the present invention has devoted himself based on his many years of practical experiences to solve these problems.

### SUMMARY OF THE INVENTION

The primary object of the present invention is to provide a linear sliding block which comprises two circulation-guiding blocks. Each of the circulation-guiding blocks comprises a first body and a mating second body. The first body comprises a rigid component and a soft cover component. The soft cover component is secondarily injection-molded on the rigid component. The soft cover component is formed with a stop portion disposed close to a sliding groove to lean against the linear sliding rail. When sliding, the stop portion is against the surface of the linear sliding rail to scrape off foreign objects, preventing foreign objects from entering the linear sliding block. The present invention can achieve precision and smoothness for sliding of the linear sliding block.

A further object of the present invention is to provide a linear sliding block which comprises two circulation-guiding blocks coupled to two opposing ends of the linear sliding blocks. The conventional oil passage is not formed in the circulation-guiding blocks, so the circulation-guiding blocks won't deform when manufactured so as to enhance its precision.

Another object of the present invention is to provide a linear sliding block which comprises two circulation-guiding blocks. The circulation-guiding blocks can be manufactured with ease to lower the manufacture cost.

### BRIEF DESCRIPTION OF THE DRAWINGS

FIG. 1 is an exploded view showing the linear sliding block and the linear sliding rail;

FIG. 2 is an exploded view showing the linear sliding block according to a preferred embodiment of the present invention;

FIG. 3 is a sectional view showing the linear sliding block of the present invention mounted on the linear sliding rail;

FIG. 4 is a schematic view showing the circulation-guiding block according to the preferred embodiment of the present invention;

FIG. 5 is another schematic view showing the circulation-guiding block according to the preferred embodiment of the present invention;

FIG. 6 is a perspective view showing the first body according to the preferred embodiment of the present invention;

FIG. 7 is an exploded view showing the first body according to the preferred embodiment of the present invention; and

FIG. 8 is another exploded view showing the first body according to the preferred embodiment of the present invention.

### DETAILED DESCRIPTION OF THE PREFERRED EMBODIMENTS

Embodiments of the present invention will now be described, by way of example only, with reference to the accompanying drawings.

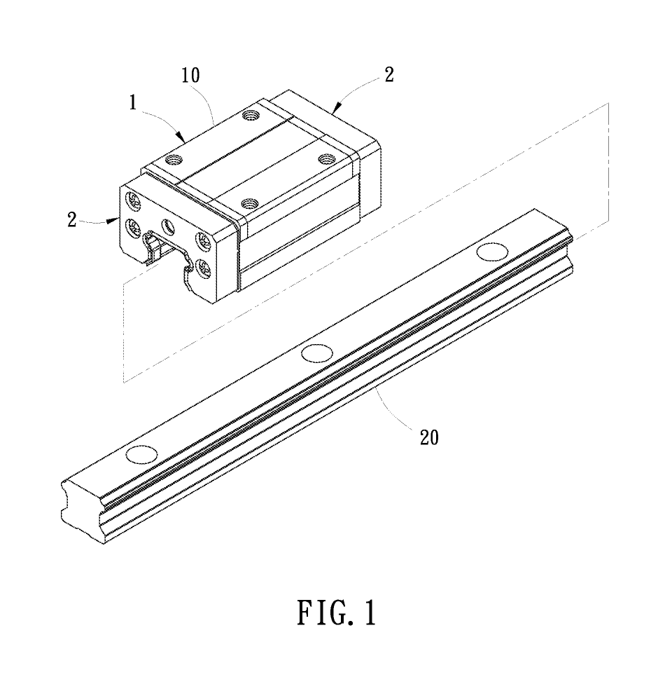

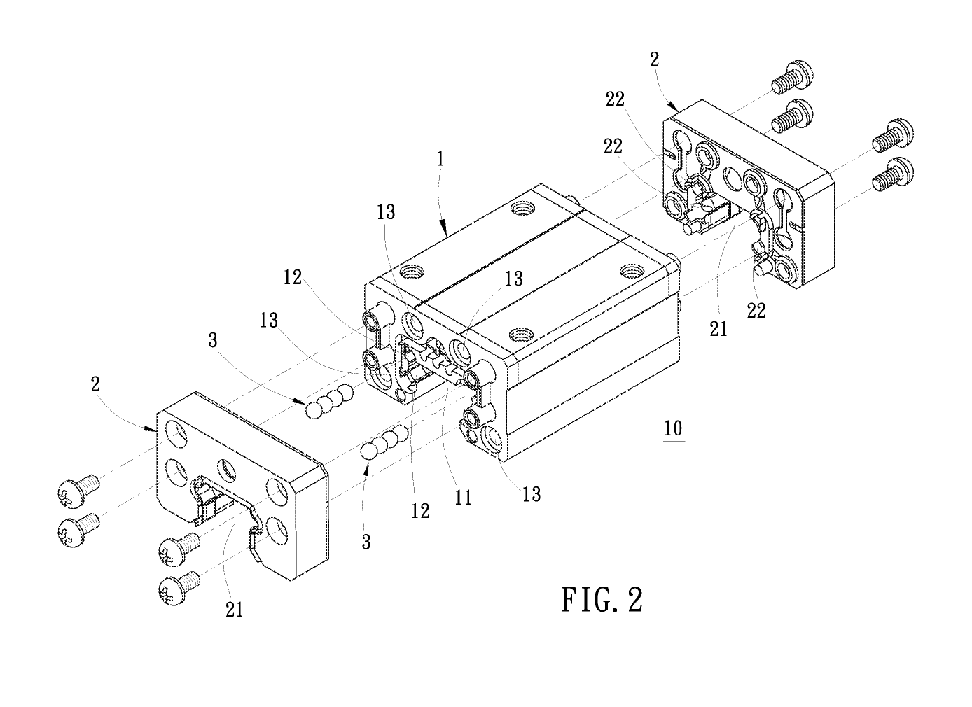

As shown in FIG. 1 and FIG. 2, a linear sliding block structure 10 mounted on a linear sliding rail 20 according to a preferred embodiment of the present invention comprises a base block 1, two circulation-guiding blocks 2 coupled to two opposing ends of the base block 1, and a plurality of rolling balls 3.

The base block 1 has a sliding groove 11, at least a pair of load-bearing tracks 12 formed at two sides of the sliding groove 11, and at least a pair of non-load tracks 13 disposed at two sides of the base block 1. The sliding groove 11, the load-bearing tracks 12 and the non-load tracks 13 communicate with the two opposing ends of the base block 1.

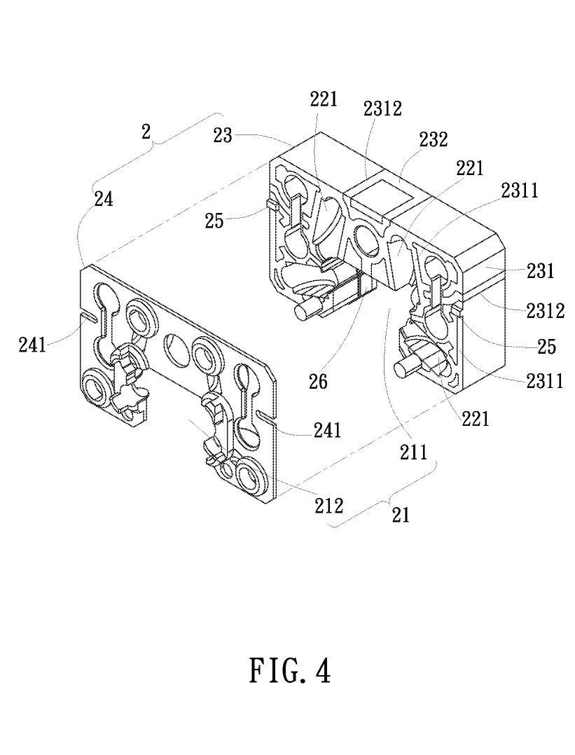

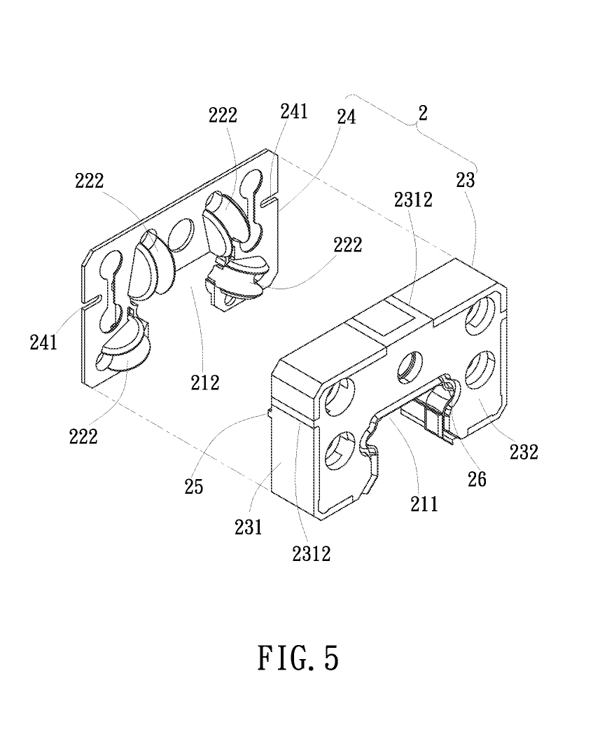

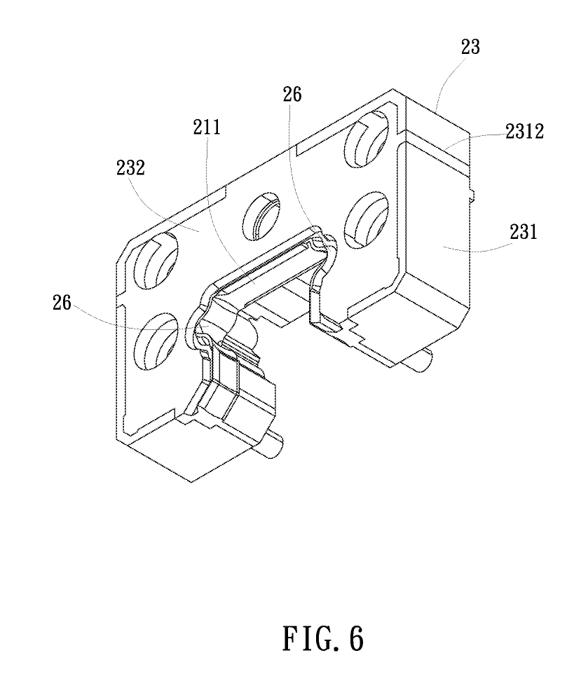

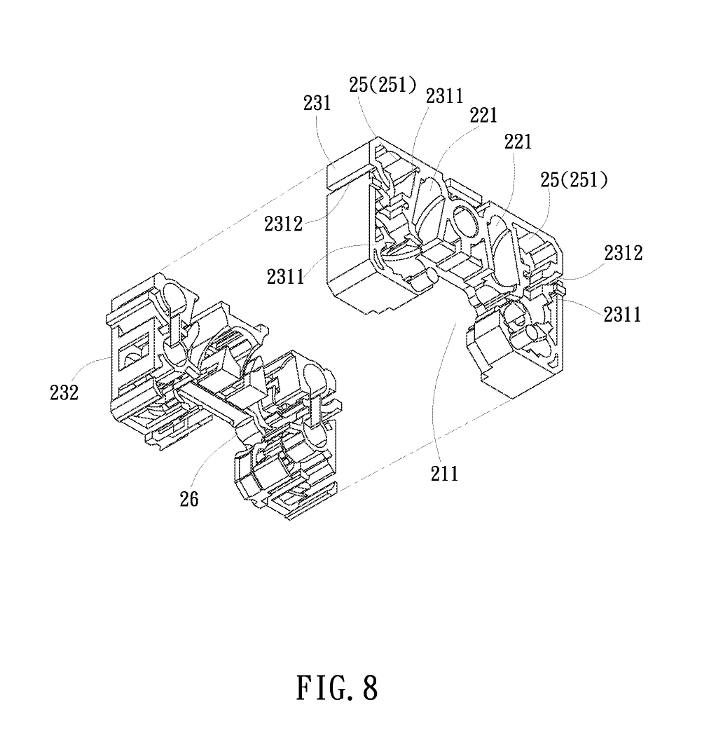

Each circulation-guiding block 2 has a sliding passage 21 corresponding to the sliding groove 11 and a circulation track 22 which is used to interconnect the load-bearing tracks 12 and the non-load tracks 13. Referring to FIG. 4 and FIG. 5, each circulation-guiding block 2 comprises a first body 23 and a mating second body 24. Referring to FIG. 6 and FIG. 8, the first body comprises a rigid component 231 and a soft cover component 232 using a dual injection molding technique, i.e., the rigid component 231 is injection-molded at the first time, and then the soft cover component 232 secondarily injection-molded on the rigid component 231. The rigid component 231 has a concaved first passage 211 to constitute the sliding passage 21. The rigid component 231 has a plurality of equally spaced ribs 2311 and a plurality of grooves 2312 defined between the ribs for binding of the soft cover component 232. The soft cover component 232 is injection-molded in the grooves 2312 of the rigid component 231 and formed with at least one stop portion 26 disposed close to the first passage 211 of the rigid component 231 to lean against the linear sliding rail 20. The second body 24 has a concaved second passage 212 corresponding to the first passage 211, so the first passage 211 and the second passage 212 are to constitute the sliding passage 21.

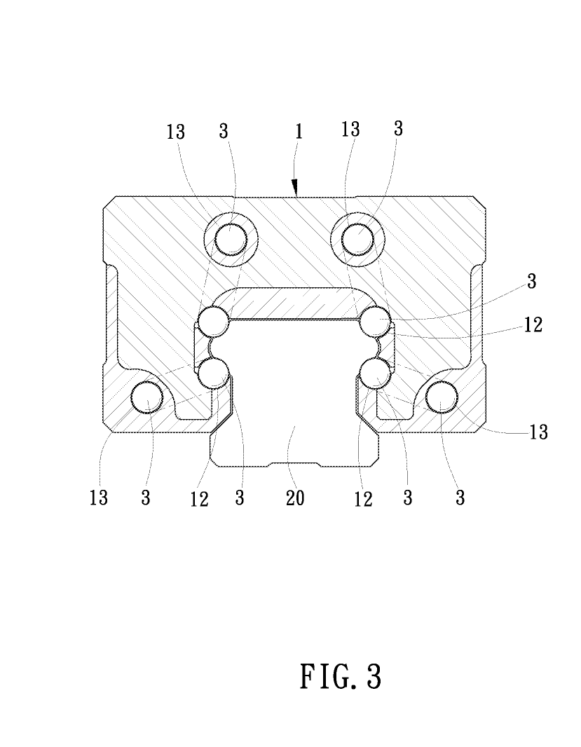

The plurality of rolling balls 3 are received in the load-bearing tracks 12 and the non-load tracks 13 of the base block 1 and the circulation tracks 22 of the two circulation-guiding blocks 2 to roll in circles along the load-bearing tracks 12, the non-load tracks 13 and the circulation tracks 22. When the rolling balls 3 roll in the load-bearing track 12, the rolling balls 3 lean against the linear sliding rails 20, as shown in FIG. 3.

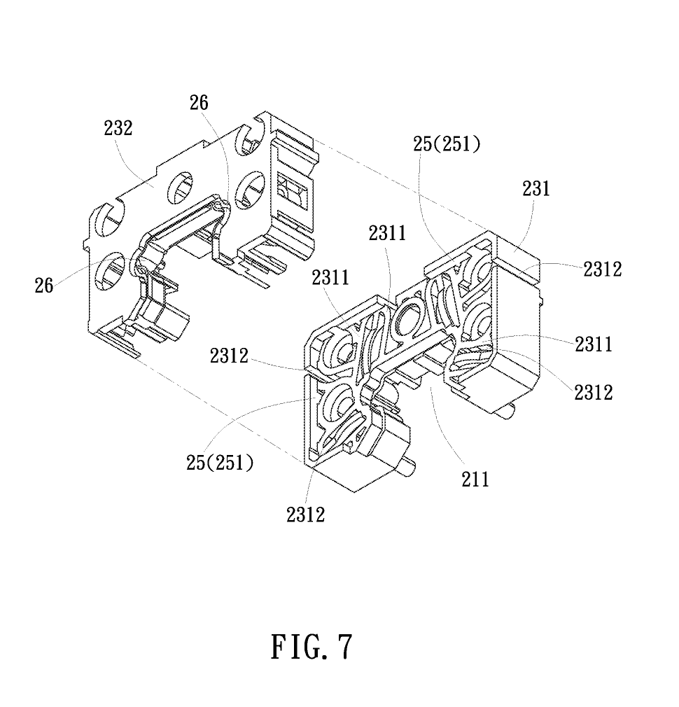

Referring to FIG. 7 and FIG. 8, the rigid component 231 of the present invention is a rigid configuration and injection-molded at the first time. The grooves 2312 extend to the edges of the rigid component 231. As shown in the drawings, the grooves 2312 extend to the two side edges and the top edge of the rigid component 231. The soft cover component 232 is formed in the grooves 2312 and extends to the edges of the rigid component 231. In this way, the soft cover component 232 and the rigid component 231 are bond stably and capable of rejecting the internal stress of the circulation-guiding blocks 2 of the present invention.

Referring to FIG. 4 and FIG. 5, the first body 23 has a first semi circulation groove 221 at a side thereof facing the second body 24. The second body 24 has a second semi circulation groove 222 at a side thereof facing the first body 23. The first semi circulation groove 221 of the first body 23 is aligned with the second semi circulation groove 222 of the second body 24 to constitute the circulation track 22. The first body 23 and the second body 24 are connected together to constitute the circulation-guiding block 2. When the two circulation-guiding blocks 2 are coupled to the two opposing ends of the base block 1, the circulation tracks 22 of the two circulation-guiding blocks 2 interconnect the load-bearing tracks 12 and the non-load tracks 13.

As shown in FIG. 4 and FIG. 5, the side of the second body 24 of the present invention has at least one notch 241 which is adapted to reject stress. The first body 23 has a protrusion 25 corresponding in position to the notch 241. The notch 241 of the second body 24 is adapted to reject the stress during forming to maintain its precision.

Through the ribs 2311 and the grooves 2312 of the rigid component 231 of the first body 23, the linear sliding block structure of the present invention can eliminate the stress deformation of plastic injection to enhance the precision of the circulation-guiding block. Besides, the ribs 2311 and the grooves 2312 of the rigid component 231 provide a base for the second injection-molding of the soft cover body 232. The stop portion 26 is integrally formed with the sliding passage 21 relative to the linear sliding rail 20. When sliding, the stop portion 26 is against the surface of the linear sliding rail 20 to scrape off foreign objects, preventing foreign objects from entering the linear sliding block 10. The present invention can achieve precision and smoothness for sliding of the linear sliding block 10. The soft cover member 232 is formed with the stop portion 26, without the need of additional process and assembly. The circulation-guiding block of the present invention can be manufactured easily to lower the cost.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A linear sliding block structure mounted on a linear sliding rail, comprising a base block, two circulation-guiding blocks coupled to two opposing ends of the base block and a plurality of rolling balls;
the base block having a sliding groove, at least a pair of load-bearing tracks formed at two sides of the sliding groove and at least a pair of non-load tracks disposed at two sides of the base block, the sliding groove, the load-bearing tracks and the non-load tracks communicating with the two opposing ends of the base block;
each of the circulation-guiding blocks having a sliding passage corresponding to the sliding groove and a circulation track which is used to interconnect the load-bearing tracks and the non-load tracks, each of the circulation-guiding blocks comprising a first body and a mating second body, the first body comprising a rigid component and a soft cover component, the rigid component having a concaved first passage, a plurality of equally spaced ribs and a plurality of grooves defined between the ribs for binding of the soft cover component, the soft cover component being injection-molded in the grooves of the rigid component, the soft cover component being formed with at least one stop portion disposed close to the first passage of the rigid component to be against the linear sliding rail, the second body having a concaved second passage corresponding to the first passage, the first passage and the second passage constituting the sliding passage;
the plurality of rolling balls being received in the load-bearing tracks and the non-load tracks of the base block and the circulation tracks of the two circulation-guiding blocks.

2. The linear sliding block structure as claimed in claim 1, wherein the grooves extend to an edge of the rigid component, and the soft cover component is formed in the grooves and extends to the edge of the rigid component.

3. The linear sliding block structure as claimed in claim 1, wherein the first body has a first semi circulation groove at a side thereof facing the second body, the second body has a second semi circulation groove at a side thereof facing the first body, and the first semi circulation groove of the first body is aligned with the second semi circulation groove of the second body to constitute the circulation track.

4. The linear sliding block structure as claimed in claim 1, wherein a side of the second body has at least one notch which is adapted to reject stress, and the first body has a protrusion corresponding in position to the notch.
